(19) United States
(12) Patent Application Publication
(10) Pub. No.: US 2017/0178068 A1
(43) Pub. Date: Jun. 22, 2017

(54) INTERNATIONAL ORDER AND SHIP OPTIMIZATION METHOD AND SYSTEM

(71) Applicant: Michael Ahn, River Edge, NJ (US)

(72) Inventor: Michael Ahn, River Edge, NJ (US)

(21) Appl. No.: 15/202,019

(22) Filed: Jul. 5, 2016

(30) Foreign Application Priority Data
Dec. 21, 2015 (KR) 10-2015-0182663

(51) Int. Cl. G06Q 10/08; G06Q 30/06; H04L 29/12

(52) U.S. Cl. CPC G06Q 10/0831; H04L 61/2567; G06Q 30/0635

(57) ABSTRACT

Disclosed is an international order and ship optimization method including a customer access environment determining step of determining an access environment of a customer who accessed an online shopping mall of a seller by recognizing a location of the customer, an address input user interface (UI) providing step of providing an address input UI displayed in a language used by the customer, and an inputted address processing step of processing the inputted address of the customer inputted in the address input UI.

### TECHNICAL FIELD

The preset disclosure relates to an international order and ship optimization method and system, and more particularly, an international order and ship optimization method and system that allows a customer to easily input an address using a language of his/her country and an address system of his/her country at a foreign online shopping mall to make the purchase of the customer easy and prevent the misdelivery of products.

### BACKGROUND ART

Recently, there is an increasing trend for purchasers to directly buy products at foreign online shopping mall sites. However, when fulfilling a purchase order at a foreign online shopping mall, a purchaser should fulfill the purchase order using a foreign language and a foreign address system, so it takes a long time for the purchaser unfamiliar wish the foreign language and the foreign address system to input an address at the purchase order fulfillment step. For this reason, the purchaser often gives up buying products at the purchase order fulfillment step.

Also, in many cases, an address inputted in a foreign language is inaccurate orthography so products are not often delivered to the address desired by the purchaser. In these cases, the purchaser has to go through an annoying procedure to get the misdelivered products.

### DISCLOSURE

### Technical Problem

The present disclosure is designed to solve the above problem, and it is an object of the present disclosure to provide an international order and ship optimization and system that allows a customer to input an address using a language of his/her country and an address system of his/her country familiar to him/her at a foreign online shopping mall to make the purchase of the customer easy and prevent the misdelivery of products.

### Technical Solution

to achieve the above object, an international order and ship optimization method according to the present disclosure includes a customer access environment determining step of determining an access environment of a customer who accessed an online shopping mall of a seller by recognizing a location of the customer, an address input user interface (UI) providing step of providing an address input UI displayed in a language used by the customer and an inputted address processing step of processing the inputted address of the customer inputted in the address input UI.

The customer access environment determining step includes a customer country determining step of determining a country of the customer by recognizing the location of the customer based on an Internet Protocol (IP) address or the customer, and a customer language determining step of determining a language of the customer based an the county of the customer.

The address input UI prodding step includes an address input template selecting step of selecting an address input template corresponding to the country of the customer from address input templates for each county.

The address input templates for each county are preferably generated by matching address systems for each county to an address system of the seller's country.

The inputted address processing step includes an inputted address verifying step of verifying the address inputted in the address input UI by matching the address system of the inputted address to the address system of the seller's country, an inputted address translating step of translating the verified inputted address to a language of the seller's country, end a shipping DB storing step of storing the inputted address of the customer in a shipping DB.

The inputted address translating step preferably translates the inputted address of the customer to the language of the seller's country using address translation data for each country stored in an international translation DB.

To achieve the above object, an international order and ship optimization system according to the present disclosure includes a customer access environment determination unit configured to determine an access environment of a customer who accessed an online shopping mall of a seller by recognizing a location of the customer, an address input UI providing unit configured to provide an address input UI displayed in a language used by the customer, and an inputted address processing unit configured to process the inputted address of the customer inputted in the address input UI.

The customer access environment determination unit includes a customer country determinate unit configured to determine a country of the customer by recognizing the location of the customer based on an IP address of the customer, and a customer language determination unit configured to determine a language of the customer based on the country of the customer.

The address input UI providing unit includes an address input template selection unit configured to select an address input template corresponding to the country of the customer from address input templates for each country.

The address input templates for each country are preferably generated by matching address systems for each country to an address system of the seller's country.

The inputted address processing unit includes an inputted address verification unit configured to verify the address inputted in the address input UI by matching the address system of the inputted address to the address system of the seller's country, an inputted address translation unit configured to translate the verified inputted address to a language of the seller's country, and a shipping DB storage unit configured to store the inputted address of the customer in a shipping DB.

The inputted address translation unit preferably translates the inputted address of the customer to the language of the seller's country using address translation date for each country stored in an international translation DB.

### Advantageous Effects

The international order and ship optimization method and system according to the present disclosure provides effects on the increased easiness of purchase end prevention of misdelivery of products, by allowing a customer so input an address using a language of his/her country and an address system of his/her country familiar to him/her at a foreign online shopping mall.

Also, there are effects on the prevention of a delivery failure caused by an address error and increased reliability by verifying the address inputted in the language of the customer's country.

Also, there is an affect on the increased operation efficiency of a person responsible for distribution/shipping by translating the address inputted in the language of the customer's country to the language of the seller's country.

Also, an advantage on the seller's position is an increase in overseas sales of products.

### DESCRIPTION OF DRAWINGS

FIG. 1 shows a flowchart according to an embodiment of an international order and ship optimization method according to the present disclosure.

FIG. 2 is a detailed flowchart of a customer access environment determining step of FIG. 1.

FIG. 3 is a detailed flowchart of an inputted address processing step of FIG. 1.

FIG. 4 schematically shows an international order end ship optimization system according to the present disclosure.

FIG. 5 is a detailed block diagram of a customer access environment determination unit of FIG. 4.

FIG. 6 is a detailed block diagram of an address input user interface (UI) providing unit of FIG. 4.

FIG. 6 is a deleted block diagram of an inputted address processing unit of FIG. 4.

### DETAILED DESCRIPTION OF MAIN ELEMENTS

10: Customer access environment determination unit

12: Customer country determination unit

14: Customer language determination unit

20: Address input UI providing unit

22: Address input template selection unit

30: Inputted address processing unit

32: Inputted address verification unit

34: Inputted address translation unit

38: Shipping DB storage unit

40: Network

50: internet shopping mall server

80: Customer terminal

### BEST MODE

Hereinafter, the present disclosure is described in further detail through the embodiments, but the scope of the present disclosure is not limited to the following embodiments.

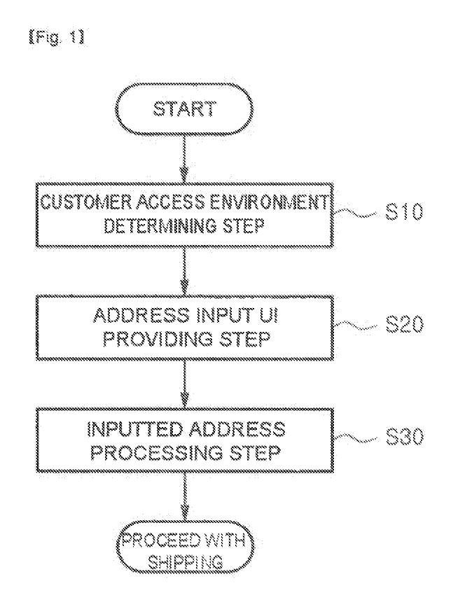

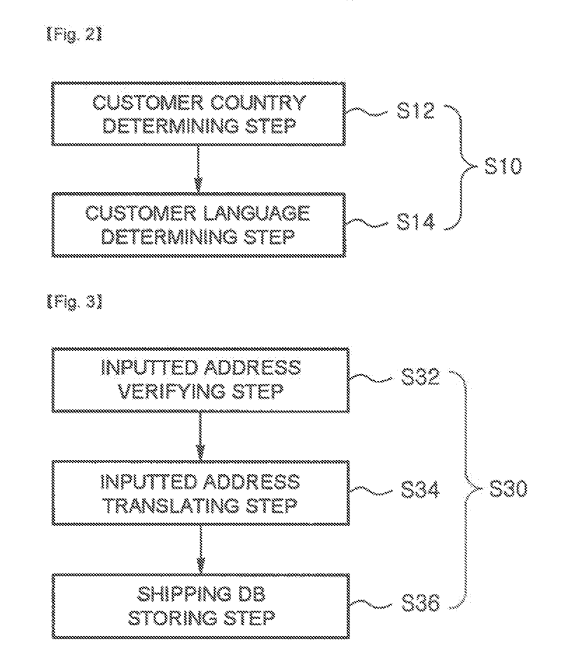

FIG. 1 shows a flowchart according to an embodiment of an international order and ship optimization method according to the present disclosure. FIG. 2 is a detailed flowchart of a customer access environment determining step of FIG. 1. FIG. 3 is a detailed flowchart of an inputted address processing step of FIG. 1.

Referring to FIG. 1, the international order and ship optimization method according to the present disclosure includes a customer access environment determining step S10, an address input user interface (UI) providing step S20, and in inputted address processing step S30.

Referring to FIGS. 1 and 2, the customer access environment determining step S10 is a step of determining an access environment of a customer who accessed an online shopping mall of a seller by recognizing a location of the customer, and includes a customer country determining step S12 of determining a country of the customer by recognizing the location of the customer based on en Internet Protocol (IP) address of the customer, and a customer language determining step S14 of determining a language of the customer based on the country of the customer. For example, when a customer bested in Korea accesses a US online shopping mall and buys a product, the country of the customer is determined to be Korea based on an IP address of the customer, and based on the determined Korea, the language of the customer is determined to be Korean language.

Referring to FIG. 1, the address input UI providing slap S20 is a step of providing an address input UI displayed in the language used by the customer, and includes an address input template selecting step of selecting an address input template corresponding to the country of the customer from address input templates for each country. For example, as described in the foregoing, after the country and the language of the customer is determined to be Korea and Korean language, a Korean address input template is selected from address input templates for each country and is provided to the customer in the form of an address input UI. The provided address input UI is displayed in the language used by the customer, i.e., Korean language, and is configured with a Korean address system, not a US address system. Thus, the customer can input his/her shipping address using a Korean address system familiar to him/her, not a US address system unfamiliar to him/her, and in Korean language, so the customer can buy a product in a convenient manner as in a Korean online shopping mall. Also, there is a low likelihood that an address is inaccurately inputted, reducing the risk of misdelivery of products.

The address input templates for each country are generated by matching address systems for each country to an address system of the seller's country, and the generated address input templates for each country are stored in a template DB. Its detailed description is provided below.

Detailed items of the address system of the seller's country are registered, An address system of a target country for generating a template is registered to comply with the format of each country. Detailed address items of the target country for generating a template are connected to the detailed address items of the seller's county. When the address system of the target country for generating a template is connected to the address system of the seller's country, the interconnected Information is coded and stored. This is referred to as a matching task.

A result of creating the address system items of the target country for generating a template having a matched code as an html document is a template. Subsequently, the inputted address of the customer has a matched code, and this code is used for inputted address verification, inputted address translation, and shipping DB storage.

The template created as a document is transmitted to a web server for customer service or synchronized to the latest version using a universal system for managing online documents, also known as a CMS system.

Referring to FIGS. 1 and 3, the inputted address processing step S30 is a step of processing the inputted address of the customer inputted in the address input UI, and includes an inputted address verifying step S35, an inputted address translating step S34 and a shipping DB storing step S36.

The inputted address verifying step S32 is a step of verifying the address inputted in the address input UI by matching the address system of the inputted address to the address system of the seller's country. For example, the address inputted by the customer is verified fey matching the address system of the customer's country, Korean address system, to the address system of the sellers country, US address system. Specifically describing, the inputted address has a matched code, and using this coda, a format and an address item of the inputted address of the customer can be determined, and the inputted address of the customer can be verified by matching to an item of the seller's address. That is, the inputted address of the customer is verified by continuously using the matched code when generating the address input templates for each country.

The inputted address translating step S34 is a step of translating the verified inputted address to the language of the seller's country. Because the seller using a different language from the language of the customer's country has difficulty in handling the product shipping operation with the address inputted in the language of the customer's country, this is for translating to the language of the sellers country to increase the efficiency of shipping operations of the seller.

The translation to the language of the seller's country may be done using address translation data for each country stored in an international translation DB. Alternatively, the inputted address of the customer may be translated to the language of the seller's county using an external translation engine such as Google Translate.

The shipping DB storing step S36 is a step of storing the inputted address of the customer in a shipping DB. By storing the inputted address of the customer undergone the verifying step in the shipping DB, misdelivery of the enter caused by an inaccurate address can be prevented.

As above, according to the international order and ship optimization method of the present disclosure, the shipping address can be inputted in the language of the customer's country on the address input UI configured with the address system of the customer's country, thereby contributing to the convenience in buying products and preventing the misdelivery of products caused by an error in address input.

Also, there are effects on the prevention of a delivery failure caused by an address error and increased reliability by verifying the address inputted in the language of the customer's country.

Also, there is an effect on the increased operation efficiency of a person responsible for distribution/shipping by translating the address inputted in the language of the customer's country to the language of the seller's country.

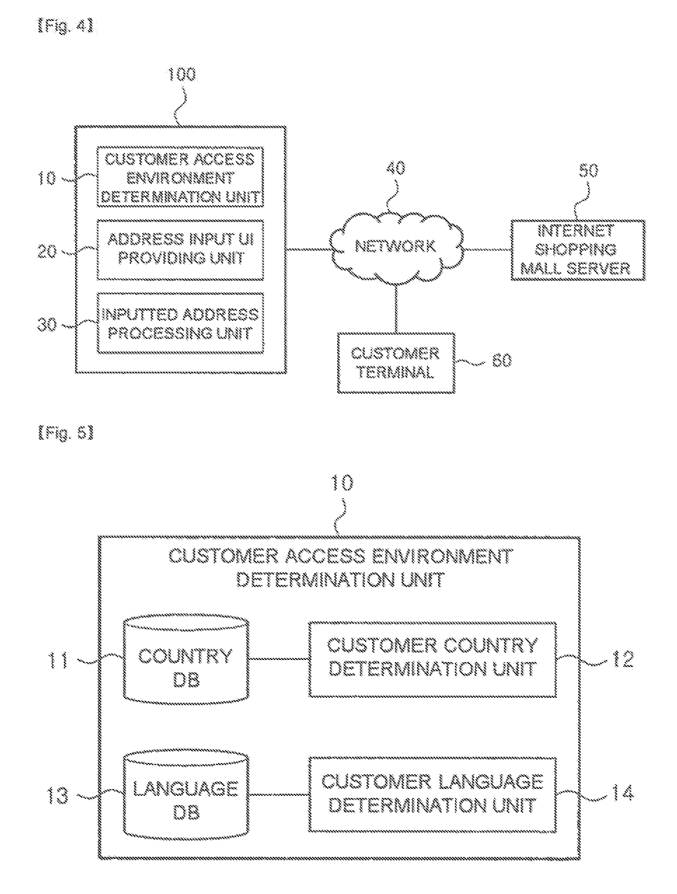

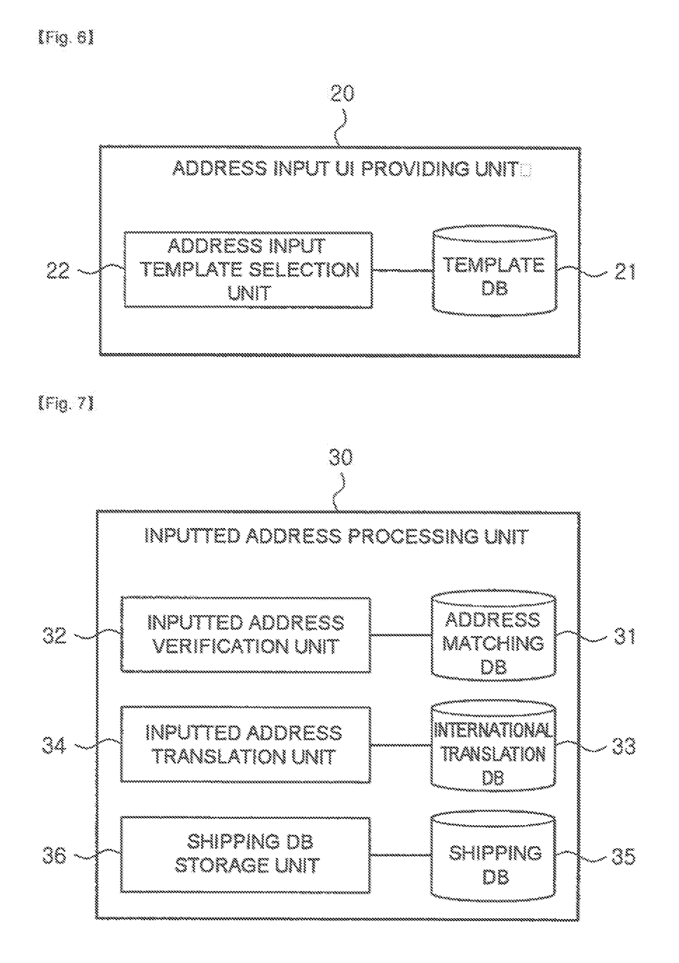

FIG. 4 schematically shows an international order and ship optimization system according to the present disclosure. FIG. 5 is a detailed block diagram of a customer access environment determination unit of FIG. 4. FIG. 6 is a detailed block diagram of an address input UI providing unit of FIG. 4. FIG. 7 is a detailed block diagram of an inputted address processing unit of FIG. 4.

Referring to FIG. 4, the international order and ship optimization system 100 according to the present disclosure includes a customer access environment determination unit 10, an address input UI providing unit 20, and an inputted address processing unit 30. The international order and ship optimization system 100 according to the present disclosure is connected to an internet shopping mall server 50 and a customer terminal 60 via a network 40. The network 40 may be a short-range communication network: and e wideband communication network such as an Internet. The customer terminal 60 may be a smart phone and a personal computer (PC).

Referring to FIGS. 4 and 5, the customer access environment determination unit 10 determines an access environment of a customer who accessed an online shopping mall of a seller by recognizing a location of the customer, and includes a customer country determination unit 12 to determine a country of the customer by recognizing the location of the customer based on an IP address of the customer and a customer language determination unit 14 to determine a language of the customer based on the country of the customer.

The customer country determination unit 12 determines the country of the customer using a country DB 11, and IP addresses are matched to corresponding countries and stored in the country DB 11.

The customer language determination unit 14 determines the language of She customer using a language DB 13, and countries are matched to languages of the corresponding countries and stored in the language DB 13.

For example, when a customer located in Korea accesses a US online shopping mall and buys a product, the country of the customer is determined to be Korea based on an IP address of the customer, and based on the determined Korea, the language of the customer is determined to be Korean language.

Referring to FIGS. 4 end Ss the address input UI providing unit 20 is a unit for providing an address input UI displayed in the language used by the customer, and includes an address input template selection unit 22 to select an address input template corresponding to the country of the customer from address input templates for each country. For example, as described in the foregoing, after the country and the language of the customer is determined to be Korea and Korean language, a Korean address input template is selected from address input templates for each country stored in a template DB 21 and is provided to the customer in the form of an address input UI. The provided address input UI is displayed in the language used by the customer, i.e., Korean language, and is configured with a Korean address system, not a US address system. Thus, the customer can input his/her shipping address using a Korean address system familiar to him/her, not a US address system unfamiliar to him/her, and in Korean language, so the customer can buy a product in a convenient manner as in a Korean online shopping mall. Also, there is a low likelihood that an address is inaccurately inputted, reducing the risk of misdelivery of products.

The address input templates for each country are generated by matching address systems for each country to an address system of the seller's country, and the generated address input templates for each country are stored in the template DB 21 as described in the foregoing. Its detailed description is provided below.

Detailed items of the address system, of the seller's country are registered. An address system of a target country for generating a template is registered to comply with the format of each country. Detailed address items of the target country for generating a template are connected to the detailed address items of the seller's country. When the address system of the seller's country for generating a template is connected to the address system of the seller's country, the interconnected information is coded and stored. This is referred to as a matching task.

A result of creating the address system items of the target country for generating a template having a matched code as an html document is a template. Subsequently, the inputted address of the customer has a matched code, and this code is used for address verification, address translation, and shipping DB storage.

The template created as a document is transmitted to a web server for customer service or synchronized to the latest version using a universal system for managing online documents, also known as a CMS system.

The address input UI providing unit 20 may further include an international postal coda DB (not shown) for storing postal codes for each country, and an international postal coda search unit (not shown) to find a postal code of an address only with a part of the address in the process of inputting the shipping address in the address UI.

Referring to FIGS. 4 and 7, the inputted address processing unit 30 is a unit for processing the inputted address of the customer inputted in the address input UI, and includes an inputted address verification unit 32, an inputted address translation unit 34, and a shipping DB storage unit 36.

The inputted address verification unit 32 is a unit for verifying the address inputted in the address input UI by matching the address system of the inputted address to the address system of the seller's country, for example, the address inputted by the customer is verified bf matching the address system of the customer's country Korean address system, to address system of the seller's country, US address system, stored in an address matching DB 31. Specifically describing, the inputted address has a matched code, and using this code, a format and an address item of the inputted address of the customer can be determined, and the inputted address of the customer can be verified by matching to an item of the seller's address. That is, the inputted address of the customer is verified by continuously using the matched code when generating the address input templates for each country,

The inputted address translation unit 34 is a unit for translating the verified inputted address to the language of the seller's country. Because the seller using a different language from the language of the customers country has difficulty in handling the product shipping operation with the address inputted in the language of the customer's country, translation to the language of the seller's country increases the efficiency of shipping operations of the seller.

The: inputted address translation unit 34 translates the inputted address of the customer to the language of the seller's country using address translation data for each country stored in an international translation DB 33. Alternatively; the inputted address of the customer may be translated to the language of the seller's country using an external translation engine such as Google Translate.

The shipping DB storage unit 36 is a unit for storing the inputted address of the customer in a shipping DB 35. By storing the verified inputted address of the customer in the shipping DB 35, misdelivery of the order caused by an inaccurate address can be prevented.

As above, according to the international order and ship optimization and system of the present disclosure, the shipping address can be inputted in the language of the customer's country on the address input UI configured with the address system of the customers country, thereby contributing to the convenience in buying products and preventing the misdelivery of products caused by an error in address input.

Also, there are effects on the prevention of a delivery failure caused by an address error and increased reliability by verifying the address inputted in the language of the customer's country.

Also, there is an effect on the increased operation efficiency of a person responsible for distribution/shipping by translating the address inputted in the language of the customer's country to the language of the seller's country.

1. An international order and ship optimization method, comprising:
a customer access environment determining step of determining an access environment of a customer who accessed an online shopping mall of a seller by recognizing a location of the customer;
an address input user interface (UI) providing step of providing an address input UI displayed in a language used by the customer; and
an inputted address processing step of processing the inputted address of the customer inputted in the address input UI.

2. The international order and ship optimization method according to claim 1, wherein the customer access environment determining step comprises:
a customer country determining step of determining a country of the customer by recognizing the location of the customer based on an Internet Protocol (IP) address of the customer; and
a customer language determining step of determining a language of the customer based on the country of the customer.

3. The international order and ship optimization method according to claim 1, wherein the address input UI providing step comprises:
an address input template selecting step of selecting an address input template corresponding to the country of the customer from address input templates for each country.

4. The international order and ship optimization method according to claim 3, wherein the address input templates for each country are generated by matching address systems for each country to an address system of the seller's country.

5. The international order and ship optimization method according to claim 1, wherein the inputted address processing step comprises:
an inputted address verifying step of verifying the address inputted in the address input UI by matching the address system of the inputted address to the address system of the seller's country;
an inputted address translating step of translating the verified inputted address to a language of the seller's country; and
a shipping DB storing step of storing the inputted address of the customer in a shipping DB.

6. The international order and ship optimization method according to claim 5, wherein the inputted address translating step composes translating the inputted address of the customer to the language of the seller's county using address translation data for each country stored in an international translation DB.

7. An international order and ship optimization system, comprising:
a customer access environment determination unit configured to determine an access environment of a customer who accessed an online shopping mall of a seller by recognizing a location of the customer;
an address input user interface (UI) providing unit configured to provide an address input UI displayed in a language used by the customer; and
an inputted address processing unit configured to process the inputted address of the customer inputted in the address input UI.

8. The international order and ship optimization system according to claim 7, wherein the customer access environment determination unit comprises:
a customer country determination unit, configured to determine a country of the customer by recognizing the location of the customer based on an internet Protocol (IP) address of the customer; and
a customer language determination unit configured to determine a language of the customer based on the country of the customer.

9. The international order and ship optimization system according to claim 7, wherein the address input UI providing unit comprises:
an address input template selection unit configured to select ac address input template corresponding to the country of the customer from address input templates for each country.

10. The international order and ship optimization system according to claim 9, wherein the address input templates for each county are generated by matching address systems for each county to an address system of the seller's country.

11. The international order and ship optimization system according to claim 7, wherein the inputted address processing unit comprises:
an inputted address verification unit configured to verify the address inputted in the address input UI by matching the address system of the inputted address to the address system of the seller's country;
an inputted address translation unit configured to translate the verified inputted address to a language of the setter's country; and
a shipping DB storage unit configured to store the inputted address of the customer in a shipping DB.

12. The international order and ship optimization system according to claim 11, wherein the inputted address translation unit translates the inputted address of the customer to the language of the seller's country using address translation data for each county stored in an international translation DB.
